(19) United States
(12) Patent Application Publication
(10) Pub. No.: US 2022/0136846 A1
(43) Pub. Date: May 5, 2022

(54) Optimal Routes for Vehicular Communications

(71) Applicant: AT&T Intellectual Property I, L.P., Atlanta, GA (US)

(72) Inventors: Abhijeet Bhorkar, Fremont, CA (US); Mehdi Malboubi, San Ramon, CA (US); Baofeng Jiang, Pleasanton, CA (US)

(73) Assignee: AT&T Intellectual Property I, L.P., Atlanta, GA (US)

(21) Appl. No.: 17/086,362

(22) Filed: Oct. 31, 2020

(51) Int. Cl. G01C 21/34; H04W 4/40; H04W 8/20

(52) U.S. Cl. CPC G01C 21/3453; H04W 8/20; H04W 4/40

(57) ABSTRACT

Concepts and technologies disclosed herein are directed to determining optimal routes for vehicular communications. According to one aspect disclosed herein, a route optimization system can obtain a quality of service (“QoS”) requirement, an origin location, and a destination location. The route optimization system also can obtain a key performance indicator (“KPI”). The route optimization system can select a route optimization model to be used for the QoS requirement. The route optimization system can determine, based upon the route optimization model and the key performance indicator, an optimized route from the origin location to the destination location that satisfies the quality of service requirement. The optimized route can be sent to a vehicle-to-everything (“V2X”)-enabled device for use in navigating from the origin location to the destination location while receiving a QoS that satisfies the QoS requirement.

### BACKGROUND

Autonomous vehicles will require sophisticated on-board sensor systems and connectivity with other vehicles, pedestrians, road infrastructure, and networks to operate safely and effectively. Technologies such as vehicle-to-vehicle communications (“V2V”) communications, vehicle-to-pedestrian communications (“V2P”), and vehicle-to-infrastructure (“V2P”) allow vehicles to communicate directly with other vehicles, pedestrians, and road infrastructure (e.g., lane markings, road signs, and traffic lights). Many current vehicles utilize these technologies for safety features such as lane keep assist, lane change assist, and autonomous modes. As vehicle manufacturers continue to move towards full autonomy, network connectivity will become paramount to their success.

Third Generation Partnership Project (“3GPP”) has developed a technology called cellular vehicle-to-everything (“C-V2X”). C-V2X utilizes existing cellular networks (e.g., Long-Term Evolution “LTE”) to facilitate network-based connectivity among vehicles, between vehicles and pedestrians (e.g., via user devices), between vehicles and infrastructure, and between vehicles and remote networks (e.g., cloud networks). In this manner, C-V2X improves upon former direct (often line-of-sight) vehicular communication technologies such as V2V, V2P, and V2I. For example, C-V2X can provide 360-degree non-line-of-sight awareness for vehicles that can support a higher level of predictability for improved road safety as an advancement towards autonomous driving. C-V2X also can provide a platform to support vehicle-to-cloud (“V2C”) applications for information, entertainment, and connected car services.

C-V2X applications may require different quality of service (“QoS”) parameters. For example, an autonomous vehicle may require a QoS that is sufficient to combine live map data with V2X data to enable autonomous vehicles to operate. Additional QoS requirements may need to be sufficient to support media (e.g., live streaming sports or other latency-sensitive content) and other content consumption by passengers (including drivers not actively engaged in driving) while the vehicle is operating in an autonomous mode. Other applications include connected cars that require reliable connectivity for control, safety, and security purposes. Telemedicine and smart ambulances may require a continuous high-speed connection to communicate with doctors and other medical personnel for critical emergency health situations.

### SUMMARY

Concepts and technologies disclosed herein are directed to aspects of determining optimal routes for vehicular communications. According to one aspect disclosed herein, a route optimization system can obtain a quality of service (“QoS”) requirement, an origin location, and a destination location. The route optimization system also can obtain a key performance indicator (“KPI”) and relevant auxiliary information from internal and external source such as weather information. The route optimization system can select a route optimization model to be used for the QoS requirement. The route optimization system can determine, based upon the route optimization model and the key performance indicator, an optimized route from the origin location to the destination location that satisfies the quality of service requirement. The optimized route can be sent to a vehicle-to-everything (“V2X”)-enabled device for use in navigating from the origin location to the destination location while receiving a QoS that satisfies the QoS requirement.

In some embodiments, the QoS, the origin location, the destination, or some combination thereof can be received via a message sent from the V2X-enabled device. Multiple messages are also contemplated. The QoS requirement can be specified by a user of the V2X-enabled device. Alternatively, the QoS requirement can be specified by an application executed by the V2X-enabled device. The application may be a vehicle-to-infrastructure (“V2I”) application or a vehicle-to-cloud (“V2C”) application, for example. In some embodiments, at least one of the QoS requirement, the origin location, or the destination location is inferred by the route optimization system.

In some embodiments, the route optimization system can obtain international mobile subscriber identity (“IMSI”)-related information or equivalent user equipment/device-related information. For example, the IMSI-related information can include a device type, device capabilities, billing information, subscription information, usage information, combinations thereof, and/or the like. The route optimization system can utilize the IMSI-related information in determining the optimized route from the origin location to the destination location that satisfies the quality of service requirement.

The route optimization system can provide the optimized route to the V2X-enabled device. In some embodiments, the route optimization system can provide multiple optimized routes from which a user of the V2X-enabled device can select.

According to another aspect of the concepts and technologies disclosed herein, the route optimization system can obtain a QoS requirement, an origin location, and a destination location. The route optimization system can determine all possible routes from the origin location to the destination location. The route optimization system can sort all the possible routes based upon a criterion. The route optimization system can sample locations along each route of the all possible routes. The route optimization system can sample locations along each route of the all possible routes. The route optimization system can predict, based upon a route optimization model, a QoS at each of the locations. The route optimization system can determine a least cost route of all the possible routes that satisfies the QoS requirement.

In some embodiments, the criterion is associated with a vehicle. The criterion, in these embodiments, can include a time or a distance for the vehicle to travel from the origin location to the destination location. In some other embodiments, the criterion is associated with a mobile network operator. The criterion, in these embodiments, can include a monetary value or a metric of network resources used for providing a service to a V2X-enabled device.

The route optimization system can provide the optimized route to the V2X-enabled device. In some embodiments, the route optimization system can provide multiple optimized routes from which a user of the V2X-enabled device can select. For example, the route optimization system can determine one or more optimized routes with single or multiple objectives and with single or multiple constraints. The route optimization system can provide the optimized route(s) using different optimization techniques, including, for example, linear, non-linear, convex, heuristic, and graph-based optimization methods.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

Other systems, methods, and/or computer program products according to embodiments will be or become apparent to one with skill in the art upon review of the following drawings and detailed description. It is intended that all such additional systems, methods, and/or computer program products be included within this description, be within the scope of this disclosure.

### BRIEF DESCRIPTION OF THE DRAWINGS

FIG. 1 is a diagram illustrating aspects of an illustrative operating environment in which various concepts and technologies disclosed herein can be implemented.

FIG. 2 is a map diagram illustrating route options between a source location and a destination location, according to an illustrative embodiment of the concepts and technologies disclosed herein.

FIG. 3 is a flow diagram illustrating aspects of a method for a V2X device to request an optimized route from an origin location to a destination location that satisfies a specified QoS requirement, according to an illustrative embodiment of the concepts and technologies disclosed herein.

FIG. 4 is a flow diagram illustrating aspects of a method for a route optimization system to determine an optimized route from an origin location to a destination location that satisfies a specified QoS requirement, according to an illustrative embodiment of the concepts and technologies disclosed herein.

FIG. 5 is a flow diagram illustrating aspects of another method for a route optimization system to determine an optimized route from an origin location to a destination location that satisfies a specified QoS requirement, according to an illustrative embodiment of the concepts and technologies disclosed herein.

FIG. 6 is a flow diagram illustrating aspects of another method for a route optimization system to determine an optimized route from an origin location to a destination location that satisfies a specified QoS requirement, according to an illustrative embodiment of the concepts and technologies disclosed herein.

FIG. 7 is a flow diagram illustrating aspects of a method for a route optimization system to create and train a route optimization model, according to an illustrative embodiment of the concepts and technologies disclosed herein.

FIG. 8 is a diagram illustrating an illustrative computer system capable of implementing aspects of the concepts and technologies disclosed herein

FIG. 9 is a diagram illustrating an illustrative network capable of implementing aspects of the concepts and technologies disclosed herein.

FIG. 10 is a diagram illustrating an illustrative cloud computing platform capable of implementing aspects of the concepts and technologies disclosed herein.

FIG. 11 is a diagram illustrating an illustrative machine learning system capable of implementing aspects of the concept and technologies disclosed herein.

FIG. 12 is a block diagram illustrating an illustrative mobile device and components thereof capable of implementing aspects of the concepts and technologies disclosed herein.

### DETAILED DESCRIPTION

The concepts and technologies disclosed herein provide reliable V2X communications for applications that have specific QoS requirements. More particularly, a route optimization system disclosed herein can create routes for a vehicle such that V2X communications can be maintained at or above a required QoS and/or to satisfy other constraints while the vehicle travels from a source location to a destination location along a route. In addition, the route optimization system disclosed herein can create optimized routes for a user, from an origin location to a destination location, such that communications can be maintained at or above a required QoS and/or to satisfy other constraints.

According to another aspect disclosed herein, the route optimization system can create routes to be used by vehicles and users for navigation over a wide coverage area provided by mobile wireless communication networks. Additionally, the routes can provide a guaranteed QoS such that if the vehicle strays or user from the route, the QoS can no longer be guaranteed and measures can be taken to ensure the safety of the vehicle and its occupants. For example, in the case of an autonomous vehicle, if the vehicle does not follow the route and the QoS therefore has been violated (or a QoS violation occurs for some other reason), the autonomous vehicle may not have access to certain features (e.g., a 360 degree view), and thus it might be safer to inform the occupants that manual mode should be engaged (i.e., an occupant must manually drive the vehicle).

According to another aspect disclosed herein, a QoS-based map application can be downloaded and installed on a V2X-enabled device, such as a vehicle, a user device, or both. The QoS-based map application can receive routes created by the route optimization system and present the routes for selection by a user. The routes can be configurable. The routes can include least cost routes with respect to distance, time, or any other metric.

Aspects disclosed herein can be implemented in a distributed manner by virtualizing and instantiating instances of the route optimization system, a V2C platform, a V2I platform, and/or other platforms, systems, and/or devices disclosed herein. In some embodiments, edge cloud computing can be used to reduce the latency of communications between vehicles and other platforms, systems, and/or devices. Moreover, content served to the V2X device can be stored at the network edge to allow the vehicle's occupants to consume content such as live streaming video while the vehicle travels along a pre-determined route.

The route optimization system can use a variety of network key performance indicators (“KPIs”) from different sources. For example, STEM, which collects real-time KPIs from network elements, can be used to incorporate the most current network KPIs into route optimization models. Other sources of KPIs are contemplated.

The concepts and technologies disclosed herein will allow network service providers to deliver their content to autonomous vehicles and to provide optimal routes for users of emergency wireless networks, such as the First Responder Network Authority (also known as FIRSTNET). The disclosed QoS-based map application can be distinguished from other map applications (e.g., GOOGLE MAPS and APPLE MAPS) because the QoS-based map application can balance vehicle traffic along routes based on required QoS. This may help increase vehicle traffic speed in congested areas, and as a result, may help reduce pollution. Users that install the QoS-based map application can opt-in to provide valuable information, such as location, that can be used by service providers in other applications such as advertising and localization.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

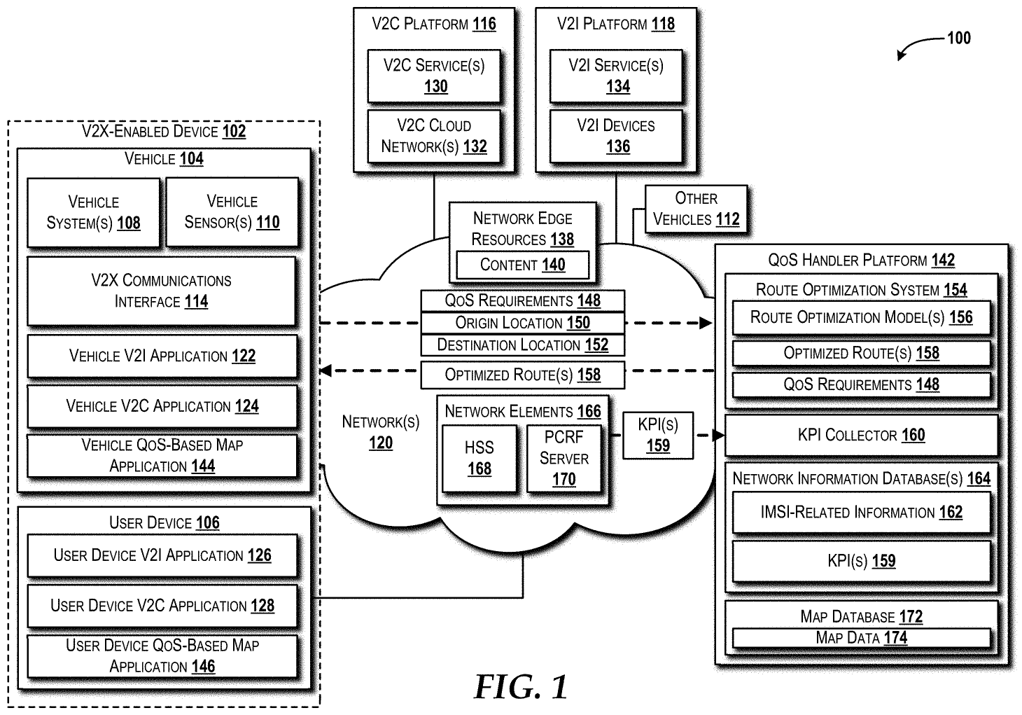

Turning now to FIG. 1, an operating environment 100 in which embodiments of the concepts and technologies disclosed herein will be described. The operating environment 100 includes a V2X-enabled device 102, which can be embodied as a vehicle 104, a user device 106, or a combination thereof. The vehicle 104 can be a car, truck, van, motorcycle, moped, go-kart, golf cart, tank, ATV, or any other ground-based vehicle. It should be understood, however, that the vehicle 104 may have amphibious and/or flight capabilities.

In some embodiments, the vehicle 104 is a driver-operated vehicle. In some embodiments, the vehicle 104 is capable of operating in a partially autonomous control mode. In some embodiments, the vehicle 104 is capable of operating in a fully autonomous control mode. In some embodiments, the vehicle 104 can operate as a Level 3 or Level 4 vehicle as defined by the National Highway Traffic Safety Administration (“NHTSA”). The NHTSA defines a Level 3 vehicle as a limited self-driving automation vehicle that enables a driver to cede full control of all safety-critical functions under certain traffic or environmental conditions and in those conditions to rely heavily on the vehicle 104 to monitor for changes in those conditions requiring transition back to driver control. The driver is expected to be available for occasional control, but with sufficiently comfortable transition time. The NHTSA defines a Level 4 vehicle as a full self-driving automation vehicle that is designed to perform all safety-critical driving functions and monitor roadway conditions for an entire trip to a destination. Such a design anticipates that the driver will provide destination or navigation input, but is not expected to be available for control at any time during the trip. It should be understood that the concepts and technologies disclosed herein are applicable to existing autonomous vehicle technologies and are readily adaptable to future autonomous vehicle technologies.

The vehicle 104 can accommodate any number of vehicle occupants (also referred to herein as “users”) each of whom can be a driver or a passenger of the vehicle 104. A vehicle occupant can be associated with the user device 106. Although any number of vehicle occupants and associated user devices 106 are contemplated, the concepts and technologies disclosed herein will be described in consideration of a single vehicle occupant (e.g., a driver) and his or her user device 106. This example is merely illustrative and should not be construed as being limiting in any way.

The manufacturer, vehicle type (e.g., car, truck, van, etc.), and/or vehicle specification, including, but not limited to, occupant capacity, gross vehicle weight, towing capacity, engine type (e.g., internal combustion, electric, or hybrid), engine size, drive type (e.g., front wheel drive, rear wheel drive, all-wheel drive, or four wheel drive), and transmission type (e.g., manual, automatic, dual clutch, continuously variable, etc.) of the vehicle 104 should not be limited in any way. The concepts and technologies disclosed herein are applicable to all vehicles 104 that have, at a minimum, a ground-based operational mode. Moreover, human-powered vehicles such as bicycles, scooters, and the like are also contemplated, although those skilled in the art will appreciate that some aspects of the concepts and technologies disclosed herein may not be applicable to these vehicle types.

According to various embodiments, the functionality of the user device 106 may be provided, at least in part, by one or more mobile telephones, smartphones, tablet computers, slate computers, smart watches, fitness devices, smart glasses, other wearable devices, mobile media playback devices, set top devices, navigation devices, laptop computers, notebook computers, ultrabook computers, netbook computers, server computers, computers of other form factors, computing devices of other form factors, other computing systems, other computing devices, Internet of Things (“IoT”) devices, other unmanaged devices, other managed devices, and/or the like. It should be understood that the functionality of the user device 106 can be provided by a single device, by two or more similar devices, and/or by two or more dissimilar devices.

The user device 106 can be configured to communicate with the vehicle 104 via a wired connection, a wireless connection, or both. In some embodiments, the user device 106 can communicate with the vehicle 104 via a short-range communication technology such as BLUETOOTH. Other wireless technologies such as Wi-Fi are also contemplated. Wired connections may be facilitated by a universal serial bus (“USB”)-based connection, although other wired connection types, including proprietary connection types are also contemplated. Moreover, the user device 106 may communicate directly or via some other interface with the vehicle 104 through one or more vehicle systems 108.

In some embodiments, the user device 106 can be integrated (permanently or temporarily) with the vehicle 104 such as part of the vehicle system(s) 108. The user device 106 may be retrofitted into the vehicle 104 as aftermarket equipment or may be made available as standard or optional original equipment manufacturer (“OEM”) equipment of the vehicle 104.

The vehicle 104 can have one or more vehicle sensors 110. The vehicle sensors 110 can provide output to one or more sensor controllers (e.g., operating as part of the vehicle system(s) 108) that can utilize the output to perform various vehicle operations. Modern vehicles have numerous systems that are controlled, at least in part, based upon the output of multiple sensors, including, for example, sensors associated with the operation of various vehicle components such as the drivetrain (e.g., engine, transmission, and differential), brakes, suspension, steering, and safety components. The concepts and technologies disclosed herein can utilize any of the vehicle sensors 110. It should be understood, however, that aspects of the concepts and technologies disclosed herein may rely on the output from sensors such as cameras, proximity sensors, radar sensors, and light detection and ranging (“LiDAR”) sensors that aid in providing the vehicle 104 with information about the environment surrounding the vehicle 104, other vehicles 112, and pedestrians (not shown). Those skilled in the art will appreciate the use of these and/or other similar sensors to enable the vehicle 104 to detect and classify objects in the environment (e.g., distinguish between roadside objects, the other vehicles 112, and pedestrians), and to perform self-driving operations (e.g., accelerate, decelerate, brake, change lanes, obey traffic signs and signals, and avoid collisions and accidents).

The vehicle system(s) 108 can include one or more systems associated with any aspect of the vehicle 104. For example, the vehicle systems 108 can include the engine, fuel system, ignition system, electrical system, exhaust system, drivetrain system, suspension system, steering system, braking system, parking assistance system (e.g., parking sensors), navigation system, radio system, infotainment system, communication system (e.g., in-car WI-FI and/or cellular connectivity), BLUETOOTH and/or other connectivity systems that allow connectivity with other systems, devices, and/or networks disclosed herein, driver assistance system (e.g., lane departure warning, lane keep assist, blind spot monitoring, parking assist, cruise control, automated cruise control, autonomous mode, semi-autonomous mode, and the like), tire pressure monitoring systems, combinations thereof, and the like. The vehicle system(s) 108 can utilize output from one or more of the vehicle sensors 110 to perform various operations, including self-driving operations, for example.

The vehicle 104 can include a V2X communications interface 114 that enables the vehicle 104 to communicate with one or more other entities, such as the other vehicles 112, a V2C platform 116, and a V2I platform 118, as will be described in greater detail below. The V2X communications interface 112 can be or can include a cellular interface, a WLAN interface, a short-range communications interface, or a combination thereof. In some embodiments, the V2X communications interface 112 is based upon a standard specification such as IEEE 802.11p (i.e., for WLAN-based V2X technology) or 3GPP C-V2X (i.e., for cellular-based V2X technology). It should be understood that as of the filing date of this patent application, V2X technology is in its infancy and the technology has not yet been widely adopted. Organizations, such as the 5G Automotive Association (“5GGA”), exist to promote the use of V2X technology. Accordingly, those skilled in the art will appreciate that the V2X communications interface 114 can be embodied in accordance with existing standards, but will likely change over time as V2X technology matures. The V2X communications interface 112 should be construed as being compatible with both current and future V2X standards. Moreover, proprietary technologies that enable V2X-type communication are also contemplated.

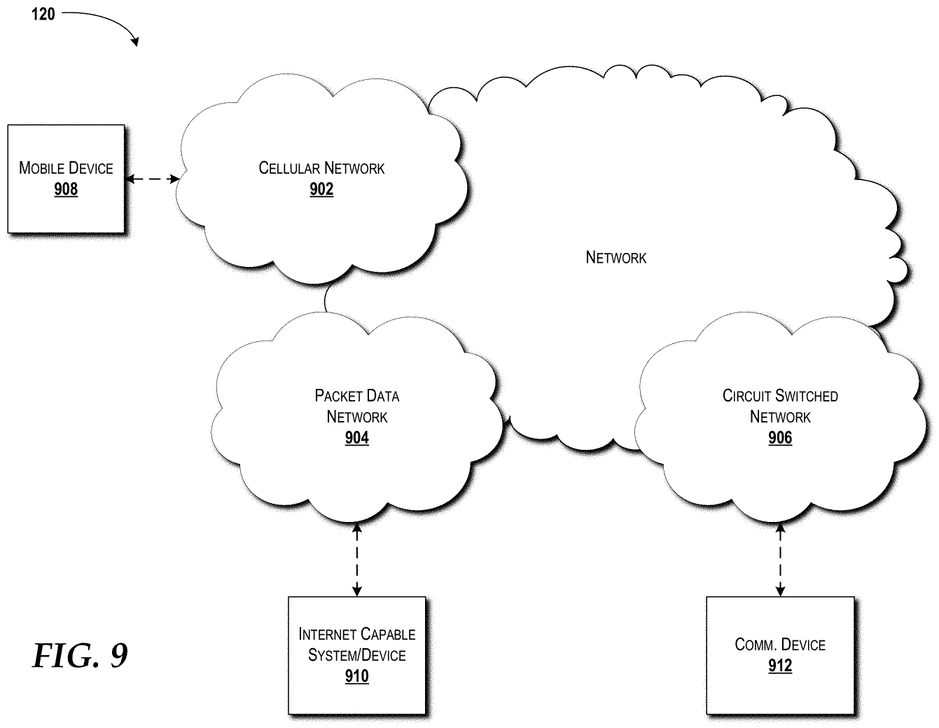

The V2X-enabled device 102, embodied as the vehicle 104, the user device 106, or a combination of both, can communicate with the V2C platform 116 and the V2I platform 118 via one or more networks 120. The network(s) 120 can be or can include one or more wireless wide area networks (“WWANs”) operated by one or more mobile network operators. The WWANs may, in turn, include one or more core networks such as a circuit-switched core network (“CS CN”), a packet-switched core network (“PS CN”), an IP multimedia subsystem (“IMS”) core network, multiples thereof, and/or combinations thereof. The WWAN can utilize one or more mobile telecommunications technologies, such as, but not limited to, Global System for Mobile communications (“GSM”), Code Division Multiple Access (“CDMA”) ONE, CDMA2000, Universal Mobile Telecommunications System (“UMT 5”), Long-Term Evolution (“LTE”), Worldwide Interoperability for Microwave Access (“WiMAX”), other 802.XX technologies (e.g., 802.11 WI-FI), and the like. The network 116 can include one or more radio access networks (“RANs”). A RAN can utilize various channel access methods (which might or might not be used by the aforementioned standards) including, but not limited to, Time Division Multiple Access (“TDMA”), Frequency Division Multiple Access (“FDMA”), Single Carrier FDMA (“SC-FDMA”), CDMA, wideband CDMA (“W-CDMA”), Orthogonal Frequency Division Multiplexing (“OFDM”), Space Division Multiple Access (“SDMA”), and/or the like to provide a radio/air interface to the V2X-enabled device 102. Data communications can be provided in part by a RAN using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and/or various other current and future wireless data access technologies. Moreover, a RAN may be a GSM RAN (“GRAN”), a GSM EDGE RAN (“GERAN”), a UMTS Terrestrial Radio Access Network (“UTRAN”), an E-UTRAN, any combination thereof, and/or the like. Those skilled in the art will appreciate the use of colloquial terms such as 1G, 2G, 3G, 4G, and 5G to describe different generations of the aforementioned technologies. An example configuration of the network 120 is illustrated and described herein with reference to FIG. 9.

The illustrated vehicle 104 can utilize a vehicle V2I application 122 and a V2C application 124 to communicate with the V2C platform 116 and the V2I platform 118, respectively. The illustrated user device 106 can utilize similar applications, shown as a user device V2I application 126 and a user device V2C application 128, respectively. Although the illustrated embodiment shows both the vehicle 104 and the user device 106 as having both of these applications stored thereon, in some embodiments, either the vehicle 104 or the user device 106 has both of these applications stored thereon. In other embodiments, the vehicle 104 may have one of these applications stored thereon and the user device 106 may have the other of these applications stored thereon. Moreover, although separate V2I and V2C applications are shown, the functionality of these applications may be combined in a single V2X application, which can be stored on either or both the vehicle 104 and the user device 106. As such, the V2X-enabled device 102 will be used herein to describe any configuration of the vehicle 104 and/or the user device 106 having the functionality of the V2I and V2C applications stored thereon so as to enable communications, via the network(s) 120, with the V2C platform 116 and the V2I platform 118. It should be understood that this embodiment should not be construed as being limiting in any way.

The V2C platform 116 can provide, to the V2X-enabled device 102, one or more V2C services 130 via one or more V2C cloud networks 132. Although the V2C platform 116 is described specifically as “vehicle-to-cloud,” the V2C platform 116 may alternatively be referred to as a “vehicle-to-network” platform to embody connectivity between the V2X-enabled device 102 and other non-cloud network types. The V2C services 130 can be or can include services, such as, but not limited to, navigation services, emergency services, concierge services, information services, entertainment services, or any combination thereof served via the V2C cloud network(s) 132. Other connected car services are contemplated as the breadth of connected car capabilities are expected to mature in the future.

The V2I platform 118 can provide one or more V2I services 134 that utilize one or more V2I devices 136, such as lane marking devices and roadside devices (e.g., signs and traffic lights), to communicate with the V2X-enabled device 102. For example, the V2I services 134 can capture, from the V2X-enabled device 102, data such as the speed and other metrics associated with the vehicle 104. These metrics can be used as part of traffic data collection. The V2I services 134 also can provide data to the V2X-enabled device 102 to inform the vehicle occupant(s) of safety information, accident information, mobility information, weather information, other environment-related condition information, and/or other information.

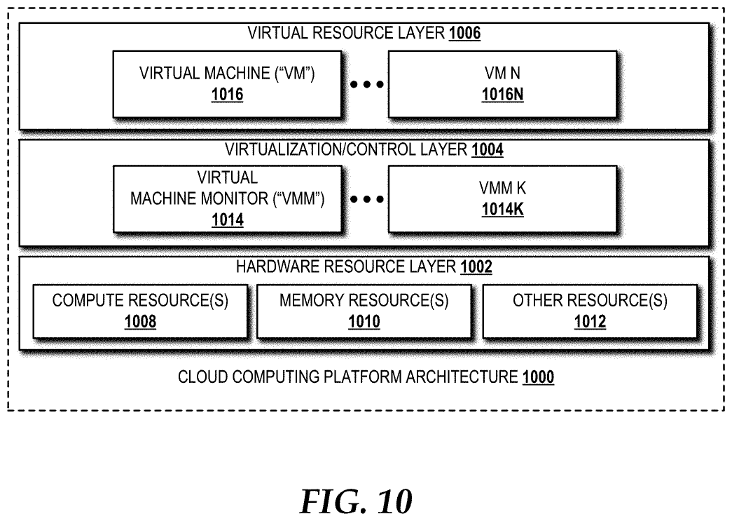

In some embodiments, at least part of the V2C platform 116 can be hosted on network edge resources 138, including cloud resources such as compute, memory/storage, and other resources. An example cloud computing platform is illustrated and described herein with reference to FIG. 10. In this configuration, content 140 associated with the V2C services 130 can be accessed quicker and more reliably. For example, if the V2C services 130 include a video streaming service, the content 140 can include video served by the network edge resources 138 (e.g., embodied as content servers) to devices such as the V2X-enabled device 102 that operate on the network(s) 120.

The illustrated V2X-enabled device 102 can communicate, via the network(s) 120, with a quality of service (“QoS”) handler platform 142. In the illustrated embodiment, the vehicle 104 can execute a vehicle QoS-based map application 144, and similarly, the user device 106 can execute a user device QoS-based map application 146 (both referred to herein collectively as “QoS-based map applications 144/146”). The QoS-based map applications 144/146 can obtain one or more QoS requirements 148 (e.g., minimum download and/or upload speed, maximum latency, signal strength, signal and channel quality, compute resources, and/or the like), an origin location 150, and a destination location 152. The QoS requirements 148 can be specified by a user of the V2X-enabled device 102. It is contemplated that other applications, such as the vehicle V2I application 122, the vehicle V2C application 124, the user device V2I application 126, and/or the user device V2C application 128 may additionally or alternatively specify one or more of the QoS requirements 148. For example, the user device V2C application 128 may be a video streaming application used by the user device 106 to access a video streaming service embodied as one of the V2C services 130, and as such, the video streaming application may request a specific minimum download speed to ensure that a specific video quality can be achieved as the vehicle 104 travels from the origin location 150 to the destination location 152. Although the QoS requirements 148 have been described specifically for data services, the QoS requirements 148 can include requirements specific to voice services, including IP-based voice services. The QoS requirements 148 can include requirements specific to mobile compute intensive applications. A function of different QoS requirements and KPIs (or other performance-related data) can also be computed as the ultimate QoS requirement.

The QoS handler platform 142 can obtain, from the QoS-based map applications 144/146, the QoS requirements 148, the origin location 150, and the destination location 152. In some embodiments, the QoS handler platform 142 can prompt the QoS-based map applications 144/146 to provide the QoS requirements 148, the origin location 150, and the destination location 152. In other embodiments, the QoS-based map applications 144/146 can provide the QoS requirements 148, the origin location 150, and the destination location 152 without first being prompted to do so by the QoS handler platform 142. Moreover, it is contemplated that the QoS requirements 148, the origin location 150, and/or the destination location 152 may be inferred by the QoS handler platform 142 based upon a history of requests made by the V2X-enabled device 102. For example, the origin location 150 may be a home location of the user and the destination location 152 may be a work location of the user, and the QoS requirements 148 may be consistent for previous routes between these locations, such that if the QoS handler platform 142 receives at least some of this information (e.g., the destination location 152 only), the QoS handler platform 142 may infer the missing information (e.g., the origin location 150 and the QoS requirements 148) based upon historical information for similar scenarios.

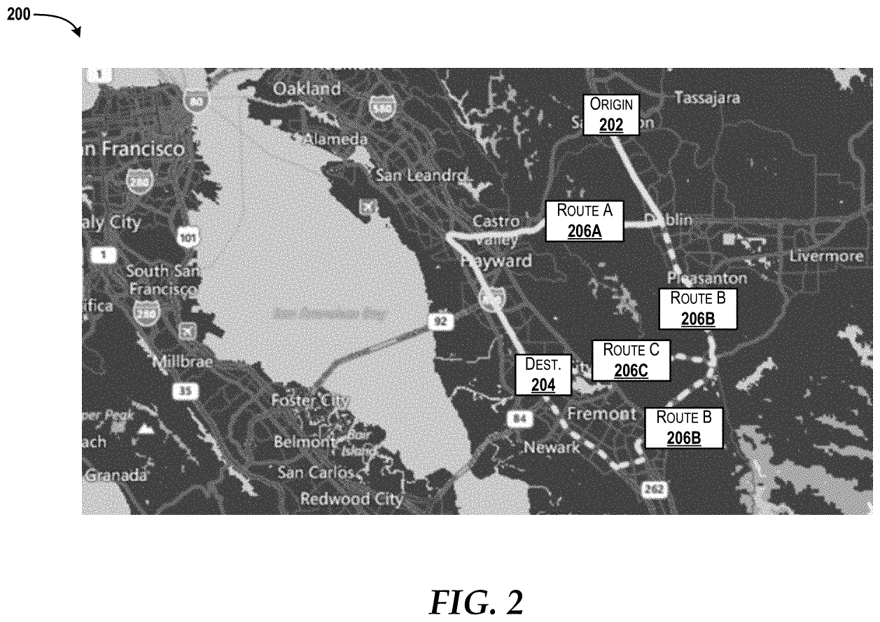

The illustrated QoS handler platform 142 includes a route optimization system 154 that utilizes one or more route optimization models 156 to generate one or more optimized routes 158 based upon the QoS requirements 148, the origin location 150, and the destination location 152. The optimized routes 158 can be considered optimized based upon least cost with respect to any specific metric or set of metrics such as distance, time, or both. For example, the optimized route 158 between the origin location 150 and the destination location 152 can be a route that is the shortest distance while still meeting or exceeding the QoS requirements 148. As another example, the optimized route 158 between the origin location 150 and the destination location 152 can be a route that takes the least time while still meeting or exceeding the QoS requirements 148. It is contemplated that the route optimization system 154 may provide multiple optimized routes 158 for the QoS requirements 148, the origin location 150, and the destination location 152. In these instances, the user can be presented, via the QoS-based map applications 144/146, with all of the optimized routes 158 from which the user can select a desired route. An example of this is best shown in FIG. 2, which will be described in detail below.

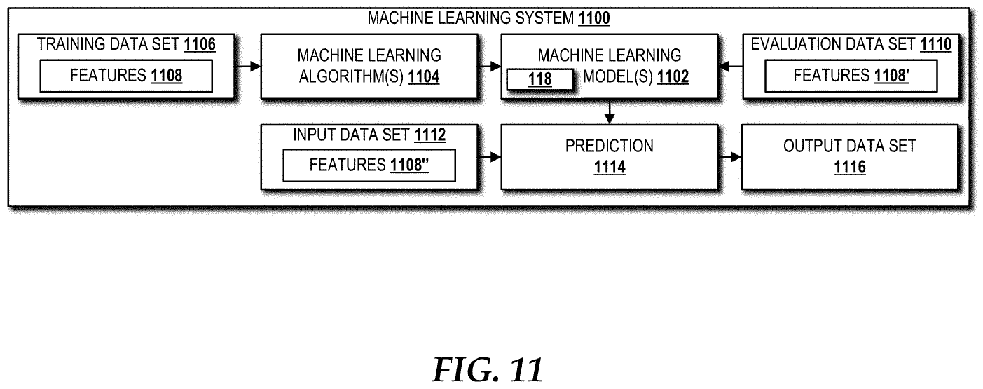

The route optimization system 154, in some embodiments, can be or can include a machine learning system. An example machine learning system is illustrated and described herein below with reference to FIG. 11. The route optimization system 154 may be configured in a similar manner. The route optimization system 154 can create the route optimization model(s) 156 based upon training data obtained from one or more various sources, including one or more key performance indicators (“KPIs”) 159 obtained by a KPI collector 160 and International Mobile Subscriber Identity (“IMSI”)-related information 162, both of which can be stored in one or more network information databases 164. As new QoS requirements 148, origin locations 150, and destination locations 152 are received, this information can be used to improve the route optimization models 156 over time. The route optimization system 154 can store the optimized route(s) 158 in association with the information used to create the optimized route(s) 158. This information can include QoS measurements, the KPIs 159, and/or other measurements/information. In some embodiments, the route optimization system 154 can construct a historical database (not shown) to store this information. The historical database can be used in different future applications and developing machine learning and artificial intelligence models where training data is used.

In some embodiments, the KPI collector 160 aggregates the KPIs 159 from multiple sources, such as one or more network elements 166 that operate as part of the network(s) 120. The KPI collector 160 can be embodied as a data collection system, which can collect the KPIs 159 from the network elements 166. The KPI collector 160 can be configured to collect the KPIs 159 in near real-time.

In addition to the KPIs 159 collected from the network elements 166, the KPI collector 160 can collect directly from the V2X-enabled device 102 (embodied as the vehicle 104 and/or the user device 106). The KPIs 159 collected from the V2X-enabled device can include, for example, observed throughput, referenced signal received power (“RSRP”) from a serving cell and/or one or more neighboring cells, a current location (e.g., expressed in terms of latitude and longitude) of the V2X-enabled device 102, one or more historical locations of the V2X-enabled device 102, some combination thereof, and/or the like. The KPIs 159 can include historical cell load data (e.g., physical resource block (“PRB”) usage), the number of active devices in a given cell, the average download and upload throughput from the base station (e.g., eNodeB for LTE and gNodeB for 5G technologies) for a specific geographical location, and the associated timestamp for when such data is collected.

In the illustrated example, the network elements 166 include a home subscriber server (“HSS”) 168 and a policy and charging rules function (“PCRF”) server 170, although other network elements 166 (e.g., an eNodeB or gNodeB) can be used as a source for one or more of the KPIs 159. The HSS 168 can store and update user identification and addressing information such as IMSI, Mobile Station International Subscriber Directory Number (“MSISDN”), and telephone number. The HSS 168 can store and update user profile information including any services to which users are subscribed, the state of service subscriptions, QoS information, and the like. The PCRF server 170 manages policies for the network 120, including authorization policies for specific QoS based upon the subscription information stored in the HSS 168. In the illustrated example, the IMSI-related information 162 can be used in addition to the KPIs 159 to determine the optimized route(s) 158. The IMSI-related information 162 can include information shared by the HSS 168 and the PCRF server 170, received from other network elements 166, and/or the V2X-enabled device 102.

The illustrated QoS handler platform 142 also includes a map database 172. The map database 172 can store map data 174 such as Geographic Information Systems (“GIS”) data, GOOGLE MAPS data, APPLE MAPS data, other proprietary map data, other public map data, and/or combinations thereof. The map data 174 can be used by the route optimization to help generate the optimized route(s) 158.

Turning now to FIG. 2, a map diagram 200 will be described, according to an illustrative embodiment of the concepts and technologies disclosed herein. The map diagram 200 shows a portion of California, USA with an origin 202 (e.g., as specified by the origin location 150 shown in FIG. 1) and a destination 204 (e.g., as specified by the destination location 152 also shown in FIG. 1) marked. In this example, the route optimization system 154 has determined three routes from the origin 202 to the destination 204, including a route A 206A, a route B 206B, and a route C 206C, that each meet or exceed the QoS requirements 148. In some embodiments, the routes 206A-206C are optimized based upon distance, time, or some other metric. Although three routes are shown, the route optimization system 154 can generate any number of routes based upon a given set of information, including the QoS requirements 148, the origin location 150, and the destination location 152. As mentioned above, all or part of this information can be provided by a user, by one of the V2I applications 122/126, and/or by one of the V2C applications 124/128. As also mentioned above, part of this information may be inferred by the route optimization system 154 based upon historical information.

The route optimization system 154 can send the routes 206A-206C to the V2X-enabled device 102 for presentation via the QoS-based map applications 144/146. A user can then select which of the routes 206A-206C to follow knowing that each at least meets the QoS requirements 148. The QoS-based map application 144/146 then functions as a map/navigation application, such as providing visual and/or audio cues to the user to enable the user to navigate the vehicle 104 along the selected route. If the vehicle 104 is operating autonomously, the vehicle 104 can utilize the vehicle sensors 110 and the vehicle systems 108 to self-navigate along the selected route.

The route optimization system 154 may, in some instances, encounter a situation in which at least a portion of at least one of the routes 206A-206C does not satisfy the QoS requirements 148. In these instances, the route optimization system 154 can inform the user, via the QoS-based map application 144/146, where along the routes 206A-206C the QoS requirements 148 are not satisfied. The user can use this information to make a more informed decision with regard to route selection. From time to time, after a route has been selected, the selected route may be compromised due to weather, network failure, or some other circumstance, and as a result, the QoS requirements 148 cannot be satisfied. In these instances, the QoS-based map application 144/146 can inform the user of the portion(s) of the selected route where the QoS requirements 148 are not satisfied. In some embodiments, the route optimization system 154 may suggest a detour that satisfies the QoS requirements 148 or at least better approaches the QoS requirements 148. In some embodiments, the user may decide to abandon the selected route and choose another one of the routes 206A-206C.

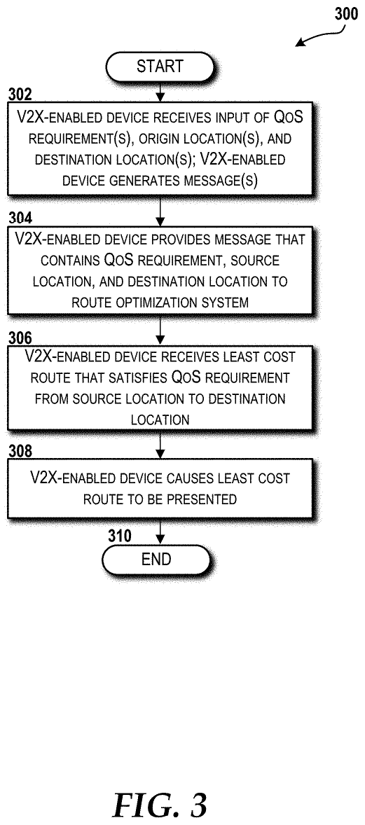

Turning now to FIG. 3, a flow diagram illustrating aspects of a method 300 for the V2X-enabled device 102 to request at least one optimized route 158 from an origin location 150 to a destination location 152 that satisfies one or more QoS requirements 148 will be described, according to an illustrative embodiment of the concepts and technologies disclosed herein. It should be understood that the operations of the method disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the method disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 300 begins and proceeds to operation 302. At operation 302, the V2X-enabled device 102 receives, via the QoS-based map application 144/146, input of at least one QoS requirement 148 to be satisfied, the origin location 150, and the destination location 152. Although the method 300 will be described from the perspective of the V2X-enabled device 102 receiving the QoS requirement(s) 148, the origin location 150, and the destination location 152, as mentioned above, one or more of these variables may be inferred by the route optimization system 154. At operation 302, the V2X-enabled device 102 can generate one or more messages that contain the QoS requirement(s) 148, the origin location 150, and the destination location 152. The embodiment illustrated in FIG. 1 shows three different messages for these variables, but these variables can be combined in a single message. It should be noted that, in the context of the concepts and technologies disclosed herein, a message is a construct used for carrying information and interacting between users, devices, systems, and/or sub-systems. Messages can be implemented in different ways, and the messages disclosed herein are not limited to any particular technology or format. As mentioned above, the QoS requirement(s) 148 can be specified by a user, by one of the V2I applications 122/126, or by one of the V2C applications 124/128. In some embodiments, the QoS requirement(s) 148 can be specified precisely. For example, a download throughput may be specified in terms of a value for bits per second (“bps”) in the form of megabits per second (“Mbps”) or gigabits per second (“Gbps”). Alternatively, in other embodiments, the QoS requirement(s) 148 can be specified generically. For example, a download throughput may be specified in terms of low, medium, or high, or based upon a desired quality of content (e.g., standard definition, high definition (720P/1080P), ultra high definition (4K/2160P), 8K definition, and/or specific frames per second for video content).

From operation 302, the method 300 proceeds to operation 304. At operation 304, the V2X-enabled device 102 provides the message(s) that contains the QoS requirement(s) 148, the origin location 150, and the destination location 152 to the route optimization system 154. From operation 304, the method 300 proceeds to operation 306. At operation 306, the V2X-enabled device 102 receives, from the route optimization system 154, at least one least cost route (i.e., optimized route(s) 158) that satisfies (i.e., meets or exceeds) the QoS requirement(s) 148 while the vehicle 104 travels from the origin location 150 to the destination location 152. In some embodiments, the route optimization system 154 may determine multiple optimized routes 158 (e.g., as shown in FIG. 2), from which a user associated with the V2X-enabled device 102 can select.

From operation 306, the method 300 proceeds to operation 308. At operation 308, the V2X-enabled device 102 causes the optimized route(s) 158 to be presented to the user (e.g., visually, audibly, or both). For example, the optimized route(s) 158 can be displayed by the QoS-based map application(s) 144/146, or alternatively may be provided to another map application such as built-in to a navigation system of the vehicle 104.

From operation 308, the method 300 proceeds to operation 310. At operation 310, the method 300 can end.

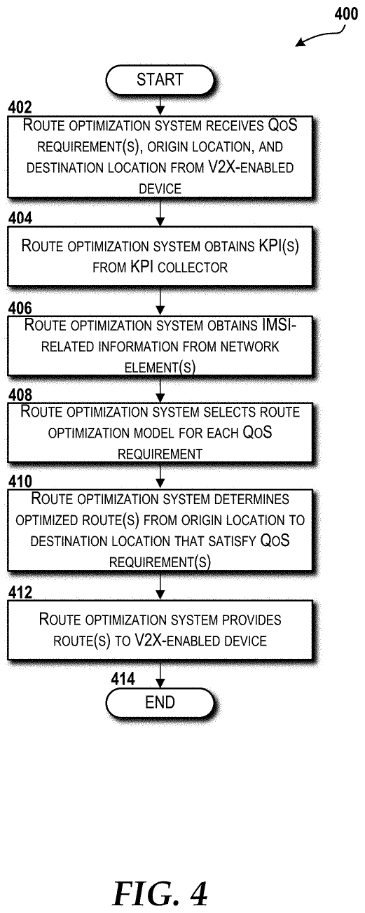

Turning now to FIG. 4, a flow diagram illustrating aspects of a method 400 for the route optimization system 154 to determine the optimized route(s) 158 from the origin location 150 to the destination location 152 that satisfies the QoS requirement(s) 148 will be described, according to an illustrative embodiment of the concepts and technologies disclosed herein. The method 400 begins and proceeds to operation 402. At operation 402, the route optimization system 154 receives, in one or more message from the V2X-enabled device 102, the QoS requirement(s) 148, the origin location 150, and the destination location 152.

From operation 402, the method 400 proceeds to operation 404. At operation 404, the route optimization system 154 obtains one or more KPIs 159 from the KPI collector 160. Although a single KPI collector 160 is described in this example, the route optimization system 154 may receive the KPIs 159 from more than one KPI collector 160. From operation 404, the method 400 proceeds to operation 406. At operation 406, the route optimization system 154 obtains the IMSI-related information 162 from the network elements 166, such as the HSS 168 and/or the PCRF server 170.

From operation 406, the method 400 proceeds to operation 408. At operation 408, the route optimization system 154 selects a route optimization model 156 to be used for each QoS requirement 148. The route optimization model 156 is described as supporting route optimization for a single QoS requirement 148. For instances in which multiple QoS requirements 148 exist, multiple route optimization models 156 can be used, with each route optimization model 156 being focused on one QoS requirement 148. It should be understood, however, a route optimization model 156 may be designed to account for multiple QoS requirements 148. For individual route optimization models 156 used for individual QoS requirements 148, the output of the route optimization models 156 can be combined to best fit one or more optimized routes 158. It is contemplated that the route optimization models 156 may be weighted in favor of or against certain QoS requirements 148 in accordance with a priority, which may be specified, for example, by the user or application that submitted the QoS requirements 148.

From operation 408, the method 400 proceeds to operation 410. At operation 410, the route optimization system 154 determines the optimized route(s) 158 from the origin location 150 to the destination location 152 that satisfy the QoS requirement(s) 148. From operation 410, the method 400 proceeds to operation 412. At operation 412, the route optimization system 154 provides the optimized route(s) 158 to the V2X-enabled device 102.

From operation 412, the method 400 proceeds to operation 414. At operation 414, the method 400 can end.

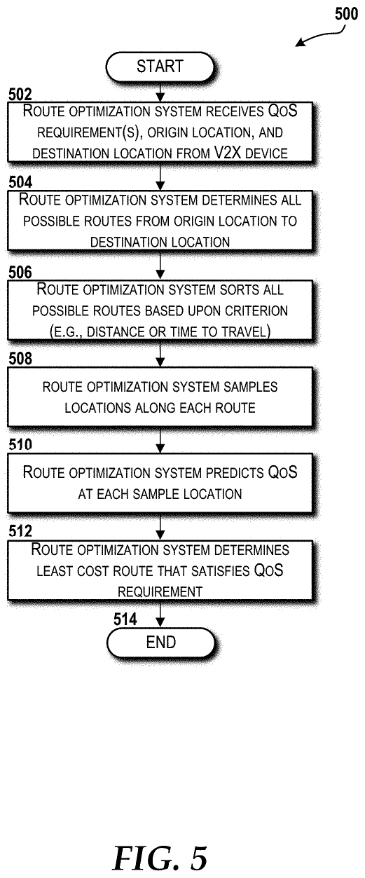

Turning now to FIG. 5, a flow diagram illustrating aspects of another method 500 for the route optimization system 154 to determine one or more optimized routes 158 from the origin location 150 to the destination location 152 that satisfy the QoS requirement(s) 148 will be described, according to an illustrative embodiment of the concepts and technologies disclosed herein. The method 500 begins and proceeds to operation 502. At operation 502, the route optimization system 154 receives, in one or more message from the V2X-enabled device, the QoS requirement(s) 148, the origin location 150, and the destination location 152.

From operation 502, the method 500 proceeds to operation 504. At operation 504, the route optimization system 154 determines all possible routes from the origin location 150 to the destination location 152. From operation 504, the method 500 proceeds to operation 506. At operation 506, the route optimization system 154 sorts all possible routes based upon a least cost criterion (e.g., distance or time to travel) or multiple criteria. It should be understood that the least cost criterion may be least cost from the perspective of the user (e.g., distance or time to travel) and/or from a mobile network operator (e.g., network resources usage or monetary cost associated with providing service along the route).

From operation 506, the method 500 proceeds to operation 508. At operation 508, the route optimization system 154 samples multiple locations along each of the possible routes. From operation 508, the method 500 proceeds to operation 510. At operation 510, the route optimization system 154 predicts the QoS at each sample location. This predication can be based upon historical QoS at each sample location.

From operation 510, the method 500 proceeds to operation 512. At operation 512, the route optimization system 154 determines the least cost route from the possible routes that satisfies the QoS requirement(s). The determined route is considered the optimized route 158.

From operation 512, the method 500 proceeds to operation 514. At operation 514, the method 500 can end.

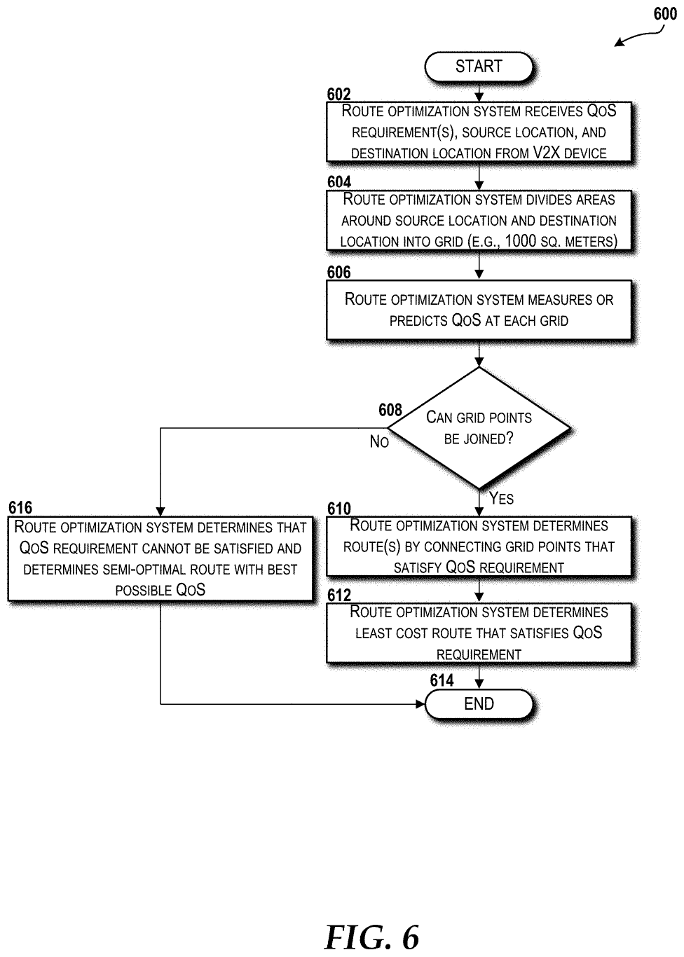

Turning now to FIG. 6, a flow diagram illustrating aspects of another method 600 for the route optimization system 154 to determine one or more optimized routes 158 from the origin location 150 to the destination location 152 that satisfy the QoS requirement(s) 148 will be described, according to an illustrative embodiment of the concepts and technologies disclosed herein. The method 600 begins and proceeds to operation 602. At operation 602, the route optimization system 154 receives, in the message from the V2X-enabled device, the QoS requirement(s) 148, the origin location 150, and the destination location 152.

From operation 602, the method 600 proceeds to operation 604. At operation 604, the route optimization system 154 divides the areas around the origin location 150 and the destination location 152 into a grid (e.g., 1000 square meters). From operation 604, the method 600 proceeds to operation 606. At operation 606, the route optimization system 154 measures or predicts the QoS at each grid. This predication can be based upon historical QoS at locations within each grid.

From operation 606, the method 600 proceeds to operation 608. At operation 608, the route optimization system 154 determines whether the grid points can be joined. If so, the method 600 proceeds to operation 610. At operation 610, the route optimization system 154 determines the optimized route(s) 148 by connecting grid points that satisfy the QoS requirement(s) 148. From operation 610, the method 600 proceeds to operation 612. At operation 612, the route optimization system 154 determines a least cost route that satisfies the QoS requirement(s) 148. The determined route is considered the optimized route 154.

From operation 612, the method 600 can proceed to operation 614. At operation 614, the method 600 can end.

Returning to operation 608, if the route optimization system 154 determines that the grid points cannot be joined, the method 600 proceeds to operation 616. At operation 616, the route optimization system 154 determines that the QoS requirement 148 cannot be satisfied and determines a semi-optimal route with the best possible QoS. From operation 616, the method 600 proceeds to operation 614. The method 600 can end at operation 614.

In one embodiment, a local area of interest is considered around the area containing the origin and destination locations. The local area of interest can have different geometric shapes such as a rectangle. Roads and routes inside the local area of interest can be partitioned into smaller segments with different shapes such as rectangular bins. This partitioning depends on different factors such as the distance between origin and destination locations, and the available compute resources. Each segment is represented by representative coordinates (“RC”) such as the latitude and longitude of the center of the segment. A graph can be constructed by considering each RC as a node in the graph and connecting RCs; for example, each RC can be connected to multiple neighboring RCs. Each connection is a considered as an edge in the graph where a weight can be computed for each edge. The edge weight between i^{th} RC and j^{th} RC is computed as a function of multiple variables, such as the QoS requirement(s) 148, network measurements, and the KPIs 159 at i^{th} RC and j^{th} RC, and the distance between i^{th} RC and j^{th} RC. In this graph, each connection can have multiple edges based on, for example, the direction and the QoS requirements 148. One or more of the optimized routes 158 with optimized costs between the origin and destination locations can be computed using different algorithms such as Dijkstra algorithm. Each of the optimized routes 158 can satisfy a single QoS requirement 148 such as the QoS requested by the user. If such an optimized route 158 is not feasible, the route optimization system 154 can provide the optimized route 158, where each segment of the optimized route 158 can have a different QoS.

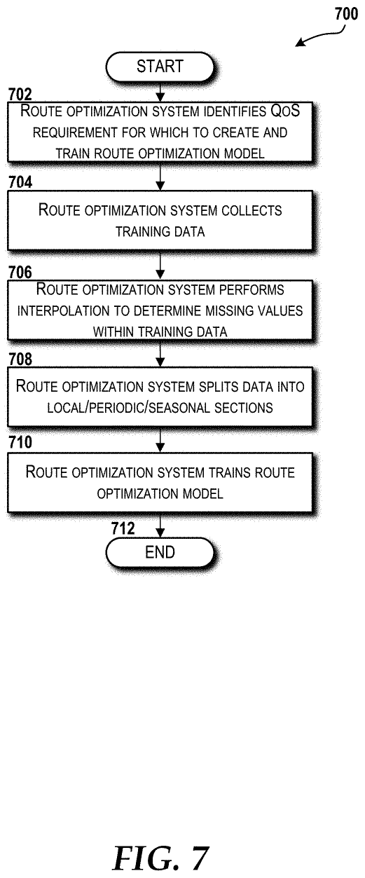

Turning now to FIG. 7, a flow diagram illustrating aspects of a method 700 for the route optimization system 154 to create and train the route optimization model 156 will be described, according to an illustrative embodiment of the concepts and technologies disclosed herein. The method 700 begins and proceeds to operation 702. At operation 702, the route optimization system 154 identifies the QoS requirement 148 for which to create and train the route optimization model 156. For purposes of explanation, and not limitation, the QoS requirement 148 for throughput will be used as an example. From operation 702, the method 700 proceeds to operation 704. At operation 704, the route optimization system 154 collects training data (best shown in FIG. 11). For example, for throughput, the training data can include observed throughput from the V2X-enabled device 102, the RSRP from the serving and neighbor cells, historical location data, IMSI model, historical cell load, the number of active devices, the average download and upload throughput from the base station (e.g., eNodeB or gNodeB), associated timestamp, and cell configuration information such as bandwidth and operating frequency.

From operation 704, the method 700 proceeds to operation 706. At operation 706, the route optimization system 154 performs interpolation to determine missing values within the training data. Interpolation can be done over time and space using a temporal-spatial interpolation technique. For example, the weighted average of measurements or KPIs at two different timestamps t1 and t2 can be computed as the estimated network measurement or KPI at a time between t1 and t2. As another example, a KPI for a location at a particular time can be computed as the weighted average of KPIs in the neighborhood at different times.

From operation 706, the method 700 proceeds to operation 708. At operation 708, the route optimization system 154 splits data into local, periodic, and/or seasonal sections. Some network measurements and KPIs contain patterns such as local, periodic, and/or seasonal patterns and can be predicted more accurately based on this pattern and by incorporating this information into the prediction model. Accordingly, from operation 708, the method 700 proceeds to operation 710. At operation 710, the route optimization system 154 trains the route optimization model 156.

From operation 710, the method 700 proceeds to operation 712. At operation 712, the method 700 can end.

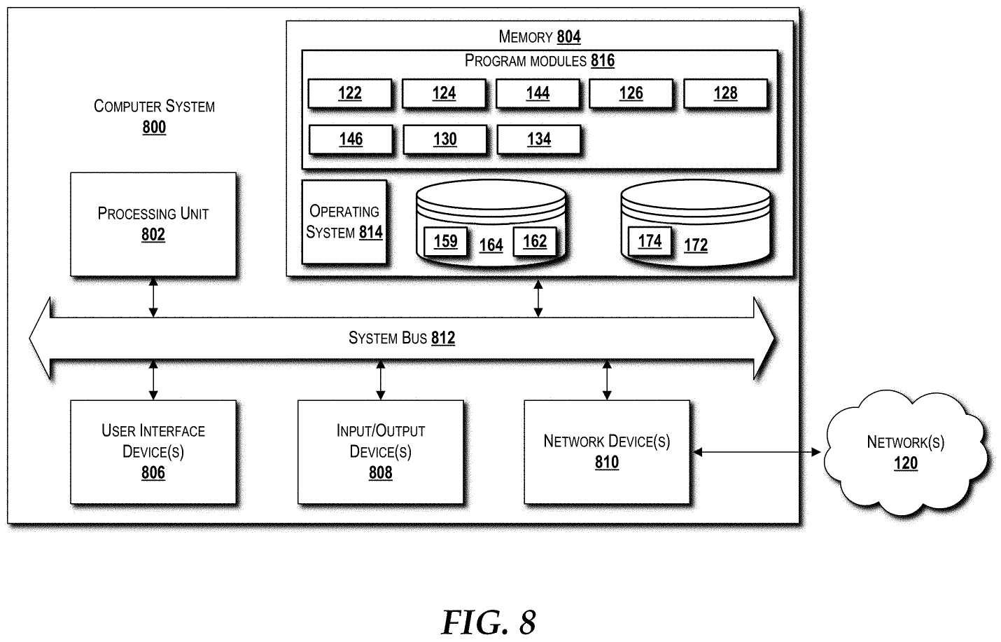

Turning now to FIG. 8, a block diagram illustrating a computer system 800 configured to provide the functionality described herein in accordance with various embodiments of the concepts and technologies disclosed herein will be described. In some embodiments, the V2X-enabled device 102, the user device 106, the vehicle system(s) 108, the V2C platform 116, the V2I platform 118, the V2I device(s) 136, the network edge resource(s) 138, the QoS handler platform 142, the route optimization system 154, the KPI collector 160, the network information database(s) 164, one or more components thereof, and/or other systems/platforms/devices/elements disclosed herein can be configured like and/or can have an architecture similar or identical to the computer system 800 described herein with respect to FIG. 8. It should be understood, however, that any of these systems, devices, platforms, or elements may or may not include the functionality described herein with reference to FIG. 8.

The computer system 800 includes a processing unit 802, a memory 804, one or more user interface devices 806, one or more input/output (“I/O”) devices 808, and one or more network devices 810, each of which is operatively connected to a system bus 812. The bus 812 enables bi-directional communication between the processing unit 802, the memory 804, the user interface devices 806, the I/O devices 808, and the network devices 810.

The processing unit 802 may be a standard central processor that performs arithmetic and logical operations, a more specific purpose programmable logic controller (“PLC”), a programmable gate array, or other type of processor known to those skilled in the art and suitable for controlling the operation of the computer system 800.

The memory 804 communicates with the processing unit 802 via the system bus 812. In some embodiments, the memory 804 is operatively connected to a memory controller (not shown) that enables communication with the processing unit 802 via the system bus 812. The memory 804 includes an operating system 814 and one or more program modules 816. The operating system 814 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, and/or iOS families of operating systems from APPLE CORPORATION, the FREEBSD family of operating systems, the SOLARIS family of operating systems from ORACLE CORPORATION, other operating systems, and the like.

The program modules 816 can include various software, program modules, and/or data described herein. For example, the program modules 816 can include the vehicle V2I application 122, the vehicle V2C application 124, the vehicle QoS-based map application 144, the user device V2I application 126, the user device V2C application 128, the user device QoS-based map application 146, the V2C services 130, and/or the V2I services 134. The memory 804 also can store the network information database(s) 164 that include the IMSI-related information 162 and the KPIs 159. The memory 804 also can store the map database 172 that includes the map data 174. The memory 804 also can store the content 140.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer storage medium,” “computer-readable storage medium,” and variations thereof does not include waves or signals per se and/or communication media, and therefore should be construed as being directed to “non-transitory” media only.

The user interface devices 806 may include one or more devices with which a user accesses the computer system 800. The user interface devices 806 may include, but are not limited to, computers, servers, personal digital assistants, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer to output data.

The network devices 810 enable the computer system 800 to communicate with other networks or remote systems via one or more networks, such as the network(s) 120 (best shown in FIG. 1). Examples of the network devices 810 include, but are not limited to, a modem, a RF or infrared (“IR”) transceiver, a telephonic interface, a bridge, a router, or a network card. The network(s) may include a wireless network such as, but not limited to, a WLAN such as a WI-FI network, a WWAN, a Wireless Personal Area Network (“WPAN”) such as BLUETOOTH, a Wireless Metropolitan Area Network (“WMAN”) such as a Worldwide Interoperability for Microwave Access (“WiMAX”) network, or a cellular network. Alternatively, the network(s) may be a wired network such as, but not limited to, a WAN such as the Internet, a LAN, a wired PAN, or a wired MAN.

Turning now to FIG. 9, additional details of an embodiment of the network 120 will be described, according to an illustrative embodiment. In the illustrated embodiment, the network 120 includes a cellular network 902, a packet data network 904, for example, the Internet, and a circuit switched network 906, for example, a publicly switched telephone network (“PSTN”). The cellular network 902 includes various components such as, but not limited to, base transceiver stations (“BTSs”), Node-B's or e-Node-B's, base station controllers (“BSCs”), radio network controllers (“RNCs”), mobile switching centers (“MSCs”), mobile management entities (“MMEs”), short message service centers (“SMSCs”), multimedia messaging service centers (“MMSCs”), home location registers (“HLRs”), HSSs (e.g., the HSS 168), visitor location registers (“VLRs”), charging platforms, billing platforms, voicemail platforms, GPRS core network components, location service nodes, an IP Multimedia Subsystem (“IMS”), and the like. The cellular network 902 also includes radios and nodes for receiving and transmitting voice, data, and combinations thereof to and from radio transceivers, networks, the packet data network 904, and the circuit switched network 906.

A mobile communications device 908, such as, for example, the V2X-enabled device 102, the user device 106, a cellular telephone, a user equipment, a mobile terminal, a PDA, a laptop computer, a handheld computer, and combinations thereof, can be operatively connected to the cellular network 902. The cellular network 902 can be configured to utilize any using any wireless communications technology or combination of wireless communications technologies, some examples of which include, but are not limited to, GSM, CDMA ONE, CDMA2000, UMTS, LTE, WiMAX), other IEEE 802.XX technologies, mmWave, and the like. The mobile communications device 908 can communicate with the cellular network 902 via various channel access methods (which may or may not be used by the aforementioned technologies), including, but not limited to, TDMA, FDMA, CDMA, W-CDMA, OFDM, SC-FDMA, SDMA, and the like. Data can be exchanged between the mobile communications device 908 and the cellular network 902 via cellular data technologies such as, but not limited to, GPRS, EDGE, the HSPA protocol family including HSDPA, EUL or otherwise termed HSUPA, HSPA+, LTE, 5G technologies, and/or various other current and future wireless data access technologies. It should be understood that the cellular network 902 may additionally include backbone infrastructure that operates on wired communications technologies, including, but not limited to, optical fiber, coaxial cable, twisted pair cable, and the like to transfer data between various systems operating on or in communication with the cellular network 902.

The packet data network 904 can include various systems/platforms/devices, for example, the V2C platform 116, the V2I platform, the network edge resources 138, the QoS handler platform 142, servers, computers, databases, and other systems/platforms/devices, in communication with one another. The packet data network 904 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 904 includes or is in communication with the Internet.

The circuit switched network 906 includes various hardware and software for providing circuit switched communications. The circuit switched network 906 may include, or may be, what is often referred to as a plain old telephone system (“POTS”). The functionality of a circuit switched network 906 or other circuit-switched network are generally known and will not be described herein in detail.

The illustrated cellular network 902 is shown in communication with the packet data network 904 and a circuit switched network 906, though it should be appreciated that this is not necessarily the case. One or more Internet-capable systems/devices 910, for example, the V2C platform 116, the V2I platform, the network edge resources 138, the QoS handler platform 142, a personal computer (“PC”), a laptop, a portable device, or another suitable device, can communicate with one or more cellular networks 902, and devices connected thereto, through the packet data network 904. It also should be appreciated that the Internet-capable device 910 can communicate with the packet data network 904 through the circuit switched network 906, the cellular network 902, and/or via other networks (not illustrated).

As illustrated, a communications device 912, for example, a telephone, facsimile machine, modem, computer, or the like, can be in communication with the circuit switched network 906, and therethrough to the packet data network 904 and/or the cellular network 902. It should be appreciated that the communications device 912 can be an Internet-capable device, and can be substantially similar to the Internet-capable device 910. It should be appreciated that substantially all of the functionality described with reference to the network 318 can be performed by the cellular network 902, the packet data network 904, and/or the circuit switched network 906, alone or in combination with additional and/or alternative networks, network elements, and the like.

Turning now to FIG. 10, a cloud computing platform architecture 1000 capable of implementing aspects of the concepts and technologies disclosed herein will be described, according to an illustrative embodiment. In some embodiments, the V2C platform 116, the network edge resources 138, the network elements 166, and/or the QoS handler platform 142 can be implemented, at least in part, on the cloud computing platform architecture 1000. Those skilled in the art will appreciate that the illustrated cloud computing platform architecture 1000 is a simplification of but one possible implementation of an illustrative cloud computing platform, and as such, the cloud computing platform architecture 1000 should not be construed as limiting in any way.

The illustrated cloud computing platform architecture 1000 includes a hardware resource layer 1002, a virtualization/control layer 1004, and a virtual resource layer 1006 that work together to perform operations as will be described in detail herein. While connections are shown between some of the components illustrated in FIG. 10, it should be understood that some, none, or all of the components illustrated in FIG. 10 can be configured to interact with one other to carry out various functions described herein. In some embodiments, the components are arranged so as to communicate via one or more networks (not shown). Thus, it should be understood that FIG. 10 and the following description are intended to provide a general understanding of a suitable environment in which various aspects of embodiments can be implemented, and should not be construed as being limiting in any way.

The hardware resource layer 1002 provides hardware resources, which, in the illustrated embodiment, include one or more compute resources 1008, one or more memory resources 1010, and one or more other resources 1012. The compute resource(s) 1006 can include one or more hardware components that perform computations to process data, and/or to execute computer-executable instructions of one or more application programs, operating systems, and/or other software. The compute resources 1008 can include one or more central processing units (“CPUs”) configured with one or more processing cores. The compute resources 1008 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 1008 can include one or more discrete GPUs. In some other embodiments, the compute resources 1008 can include CPU and GPU components that are configured in accordance with a co-processing CPU/GPU computing model, wherein the sequential part of an application executes on the CPU and the computationally-intensive part is accelerated by the GPU. The compute resources 1008 can include one or more system-on-chip (“SoC”) components along with one or more other components, including, for example, one or more of the memory resources 1010, and/or one or more of the other resources 1012. In some embodiments, the compute resources 1008 can be or can include one or more SNAPDRAGON SoCs, available from QUALCOMM of San Diego, Calif.; one or more TEGRA SoCs, available from NVIDIA of Santa Clara, Calif.; one or more HUMMINGBIRD SoCs, available from SAMSUNG of Seoul, South Korea; one or more Open Multimedia Application Platform (“OMAP”) SoCs, available from TEXAS INSTRUMENTS of Dallas, Tex.; one or more customized versions of any of the above SoCs; and/or one or more proprietary SoCs. The compute resources 1008 can be or can include one or more hardware components architected in accordance with an ARM architecture, available for license from ARM HOLDINGS of Cambridge, United Kingdom. Alternatively, the compute resources 1008 can be or can include one or more hardware components architected in accordance with an x86 architecture, such an architecture available from INTEL CORPORATION of Mountain View, Calif., and others. Those skilled in the art will appreciate the implementation of the compute resources 1008 can utilize various computation architectures, and as such, the compute resources 1008 should not be construed as being limited to any particular computation architecture or combination of computation architectures, including those explicitly disclosed herein.

The memory resource(s) 1010 can include one or more hardware components that perform storage operations, including temporary or permanent storage operations. In some embodiments, the memory resource(s) 1010 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 1008.

The other resource(s) 1012 can include any other hardware resources that can be utilized by the compute resources(s) 1006 and/or the memory resource(s) 1010 to perform operations. The other resource(s) 1012 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 1002 can be virtualized by one or more virtual machine monitors (“VMMs”) 1014A-1014K (also known as “hypervisors”; hereinafter “VMMs 1014”) operating within the virtualization/control layer 1004 to manage one or more virtual resources that reside in the virtual resource layer 1006. The VMMs 1014 can be or can include software, firmware, and/or hardware that alone or in combination with other software, firmware, and/or hardware, manages one or more virtual resources operating within the virtual resource layer 1006.

The virtual resources operating within the virtual resource layer 1006 can include abstractions of at least a portion of the compute resources 1008, the memory resources 1010, the other resources 1012, or any combination thereof. These abstractions are referred to herein as virtual machines (“VMs”). In the illustrated embodiment, the virtual resource layer 1006 includes VMs 1016A-1016N (hereinafter “VMs 1016”).

Turning now to FIG. 11, a machine learning system 1100 capable of implementing aspects of the embodiments disclosed herein will be described. In some embodiments, the route optimization system 154 can be configured to provide machine learning functionality to train the route optimization models 156 and to determine the optimized routes 158 for given sets of QoS requirements 148, origin locations 150, destination locations 152.

The illustrated machine learning system 1100 includes one or more machine learning models 1102 (e.g., the route optimization models 15)6. The machine learning models 1102 can include supervised and/or semi-supervised learning models. The machine learning model(s) 1102 can be created by the machine learning system 1100 based upon one or more machine learning algorithms 1104. The machine learning algorithm(s) 1104 can be any existing, well-known algorithm, any proprietary algorithms, or any future machine learning algorithm. Some example machine learning algorithms 1104 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 1104 based upon the problem(s) to be solved by machine learning via the machine learning system 1100.

The machine learning system 1100 can control the creation of the machine learning models 1102 via one or more training parameters. In some embodiments, the training parameters are selected modelers at the direction of an enterprise, for example. Alternatively, in some embodiments, the training parameters are automatically selected based upon data provided in one or more training data sets 1106. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 1104 converges to the optimal weights. The machine learning algorithm 1104 can update the weights for every data example included in the training data set 1106. The size of an update is controlled by the learning rate. A learning rate that is too high might prevent the machine learning algorithm 1104 from converging to the optimal weights. A learning rate that is too low might result in the machine learning algorithm 1104 requiring multiple training passes to converge to the optimal weights.

The model size is regulated by the number of input features (“features”) 1106 in the training data set 1106. A greater the number of features 1108 yields a greater number of possible patterns that can be determined from the training data set 1106. The model size should be selected to balance the resources (e.g., compute, memory, storage, etc.) needed for training and the predictive power of the resultant machine learning model 1102.

The number of training passes indicates the number of training passes that the machine learning algorithm 1104 makes over the training data set 1106 during the training process. The number of training passes can be adjusted based, for example, on the size of the training data set 1106, with larger training data sets being exposed to fewer training passes in consideration of time and/or resource utilization. The effectiveness of the resultant machine learning model 1102 can be increased by multiple training passes.

Data shuffling is a training parameter designed to prevent the machine learning algorithm 1104 from reaching false optimal weights due to the order in which data contained in the training data set 1106 is processed. For example, data provided in rows and columns might be analyzed first row, second row, third row, etc., and thus an optimal weight might be obtained well before a full range of data has been considered. By data shuffling, the data contained in the training data set 1106 can be analyzed more thoroughly and mitigate bias in the resultant machine learning model 1102.

Regularization is a training parameter that helps to prevent the machine learning model 1102 from memorizing training data from the training data set 1106. In other words, the machine learning model 1102 fits the training data set 1106, but the predictive performance of the machine learning model 1102 is not acceptable. Regularization helps the machine learning system 1100 avoid this overfitting/memorization problem by adjusting extreme weight values of the features 1108. For example, a feature that has a small weight value relative to the weight values of the other features in the training data set 1106 can be adjusted to zero.

The machine learning system 1100 can determine model accuracy after training by using one or more evaluation data sets 1110 containing the same features 1108′ as the features 1108 in the training data set 1106. This also prevents the machine learning model 1102 from simply memorizing the data contained in the training data set 1106. The number of evaluation passes made by the machine learning system 1100 can be regulated by a target model accuracy that, when reached, ends the evaluation process and the machine learning model 1102 is considered ready for deployment.

After deployment, the machine learning model 1102 can perform a prediction operation (“prediction”) 1114 with an input data set 1112 having the same features 1108″ as the features 1108 in the training data set 1106 and the features 1108′ of the evaluation data set 1110. The results of the prediction 1114 are included in an output data set 1116 consisting of predicted data. The machine learning model 1102 can perform other operations, such as regression, classification, and others. As such, the example illustrated in FIG. 11 should not be construed as being limiting in any way.

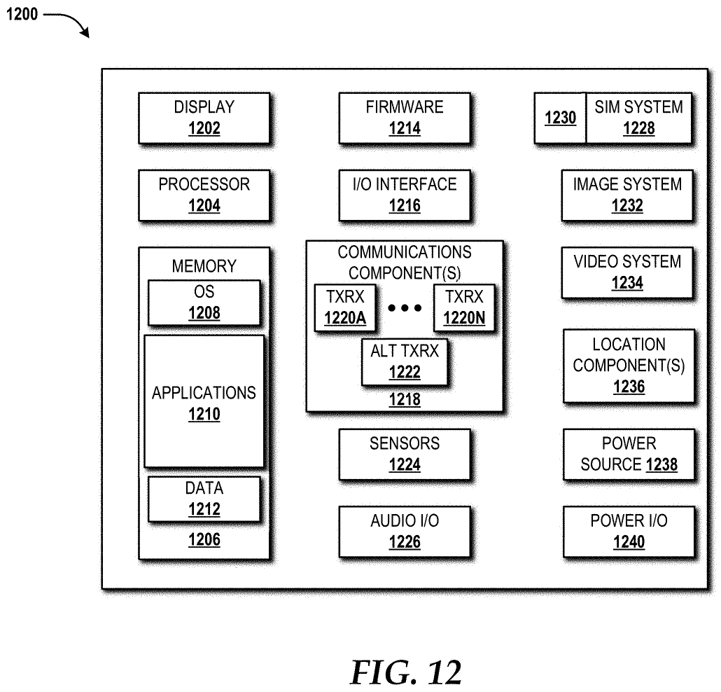

Turning now to FIG. 12, an illustrative mobile device 1200 and components thereof will be described. In some embodiments, the V2X-enabled device 102 and/or the user device 106 are configured similar to or the same as the mobile device 1200. While connections are not shown between the various components illustrated in FIG. 12, it should be understood that some, none, or all of the components illustrated in FIG. 12 can be configured to interact with one another to carry out various device functions. In some embodiments, the components are arranged so as to communicate via one or more busses (not shown). Thus, it should be understood that FIG. 12 and the following description are intended to provide a general understanding of a suitable environment in which various aspects of embodiments can be implemented, and should not be construed as being limiting in any way.

As illustrated in FIG. 12, the mobile device 1200 can include a display 1202 for displaying data. According to various embodiments, the display 1202 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 1200 also can include a processor 1204 and a memory or other data storage device (“memory”) 1206. The processor 1204 can be configured to process data and/or can execute computer-executable instructions stored in the memory 1206. The computer-executable instructions executed by the processor 1204 can include, for example, an operating system 1208, one or more applications 1210 (e.g., the vehicle V2I application 122, the vehicle V2C application 124, the vehicle QoS-based map application 144, the user device V2I application 126, the user device V2C application 128, the user device QoS-based map application 146), other computer-executable instructions stored in the memory 1206, or the like. In some embodiments, the applications 1210 also can include a UI application (not illustrated in FIG. 12).

The UI application can interface with the operating system 1208 to facilitate user interaction with functionality and/or data stored at the mobile device 1200 and/or stored elsewhere. In some embodiments, the operating system 1208 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 1204 to aid a user in entering/deleting data, entering and setting user IDs and passwords for device access, configuring settings, manipulating content and/or settings, multimode interaction, interacting with other applications 1210, and otherwise facilitating user interaction with the operating system 1208, the applications 1210, and/or other types or instances of data 1212 that can be stored at the mobile device 1200.

The applications 1210, the data 1212, and/or portions thereof can be stored in the memory 1206 and/or in a firmware 1214, and can be executed by the processor 1204. The firmware 1214 also can store code for execution during device power up and power down operations. It can be appreciated that the firmware 1214 can be stored in a volatile or non-volatile data storage device including, but not limited to, the memory 1206 and/or a portion thereof.

The mobile device 1200 also can include an input/output (“I/O”) interface 1216. The I/O interface 1216 can be configured to support the input/output of data such as location information, presence status information, user IDs, passwords, and application initiation (start-up) requests. In some embodiments, the I/O interface 1216 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 1200 can be configured to synchronize with another device to transfer content to and/or from the mobile device 1200. In some embodiments, the mobile device 1200 can be configured to receive updates to one or more of the applications 1210 via the I/O interface 1216, though this is not necessarily the case. In some embodiments, the I/O interface 1216 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1216 may be used for communications between the mobile device 1200 and a network device or local device.

The mobile device 1200 also can include a communications component 1218. The communications component 1218 can be configured to interface with the processor 1204 to facilitate wired and/or wireless communications with one or more networks, such as the network 116, the Internet, or some combination thereof. In some embodiments, the communications component 1218 includes a multimode communications subsystem for facilitating communications via the cellular network and one or more other networks.

The communications component 1218, in some embodiments, includes one or more transceivers. The one or more transceivers, if included, can be configured to communicate over the same and/or different wireless technology standards with respect to one another. For example, in some embodiments, one or more of the transceivers of the communications component 1218 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 1218 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 1218 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 1218 can include a first transceiver (“TxRx”) 1220A that can operate in a first communications mode (e.g., GSM). The communications component 1218 also can include an Nth transceiver (“TxRx”) 1220N that can operate in a second communications mode relative to the first transceiver 1220A (e.g., UMTS). While two transceivers 1220A-1220N (hereinafter collectively and/or generically referred to as “transceivers 1220”) are shown in FIG. 12, it should be appreciated that less than two, two, and/or more than two transceivers 1220 can be included in the communications component 1218.

The communications component 1218 also can include an alternative transceiver (“Alt TxRx”) 1222 for supporting other types and/or standards of communications. According to various contemplated embodiments, the alternative transceiver 1222 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 1218 also can facilitate reception from terrestrial radio networks, digital satellite radio networks, internet-based radio service networks, combinations thereof, and the like. The communications component 1218 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 1200 also can include one or more sensors 1224. The sensors 1224 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 1200 may be provided by an audio I/O component 1226. The audio I/O component 1226 of the mobile device 1200 can include one or more speakers for the output of audio signals, one or more microphones for the collection and/or input of audio signals, and/or other audio input and/or output devices.

The illustrated mobile device 1200 also can include a subscriber identity module (“SIM”) system 1228. The SIM system 1228 can include a universal SIM (“USIM”), a universal integrated circuit card (“UICC”) and/or other identity devices. The SIM system 1228 can include and/or can be connected to or inserted into an interface such as a slot interface 1230. In some embodiments, the slot interface 1230 can be configured to accept insertion of other identity cards or modules for accessing various types of networks. Additionally, or alternatively, the slot interface 1230 can be configured to accept multiple subscriber identity cards. Because other devices and/or modules for identifying users and/or the mobile device 1200 are contemplated, it should be understood that these embodiments are illustrative, and should not be construed as being limiting in any way.

The mobile device 1200 also can include an image capture and processing system 1232 (“image system”). The image system 1232 can be configured to capture or otherwise obtain photos, videos, and/or other visual information. As such, the image system 1232 can include cameras, lenses, charge-coupled devices (“CCDs”), combinations thereof, or the like. The mobile device 1200 may also include a video system 1234. The video system 1234 can be configured to capture, process, record, modify, and/or store video content. Photos and videos obtained using the image system 1232 and the video system 1234, respectively, may be added as message content to an MMS message, email message, and sent to another device. The video and/or photo content also can be shared with other devices via various types of data transfers via wired and/or wireless communication devices as described herein.

The mobile device 1200 also can include one or more location components 1236. The location components 1236 can be configured to send and/or receive signals to determine a geographic location of the mobile device 1200. According to various embodiments, the location components 1236 can send and/or receive signals from global positioning system (“GPS”) devices, assisted-GPS (“A-GPS”) devices, WI-FI/WIMAX and/or cellular network triangulation data, combinations thereof, and the like. The location component 1236 also can be configured to communicate with the communications component 1218 to retrieve triangulation data for determining a location of the mobile device 1200. In some embodiments, the location component 1236 can interface with cellular network nodes, telephone lines, satellites, location transmitters and/or beacons, wireless network transmitters and receivers, combinations thereof, and the like. In some embodiments, the location component 1236 can include and/or can communicate with one or more of the sensors 1224 such as a compass, an accelerometer, and/or a gyroscope to determine the orientation of the mobile device 1200. Using the location component 1236, the mobile device 1200 can generate and/or receive data to identify its geographic location, or to transmit data used by other devices to determine the location of the mobile device 1200. The location component 1236 may include multiple components for determining the location and/or orientation of the mobile device 1200.

The illustrated mobile device 1200 also can include a power source 1238. The power source 1238 can include one or more batteries, power supplies, power cells, and/or other power subsystems including alternating current (“AC”) and/or direct current (“DC”) power devices. The power source 1238 also can interface with an external power system or charging equipment via a power I/O component 1240. Because the mobile device 1200 can include additional and/or alternative components, the above embodiment should be understood as being illustrative of one possible operating environment for various embodiments of the concepts and technologies described herein. The described embodiment of the mobile device 1200 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 1200 or other devices or computers described herein, such as the computer system 800 described above with reference to FIG. 8. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 1200 in order to store and execute the software components presented herein. It is also contemplated that the mobile device 1200 may not include all of the components shown in FIG. 12, may include other components that are not explicitly shown in FIG. 12, or may utilize an architecture completely different than that shown in FIG. 12.

Based on the foregoing, it should be appreciated that aspects of aspects of determining optimal routes for vehicular communications have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
obtaining, by a route optimization system comprising a processor, a quality of service requirement, an origin location, and a destination location;
obtaining, by the route optimization system, a key performance indicator;
selecting, by the route optimization system, a route optimization model for the quality of service requirement; and
determining, by the route optimization system, based upon the route optimization model and the key performance indicator, an optimized route from the origin location to the destination location that satisfies the quality of service requirement.

2. The method of claim 1, wherein obtaining the quality of service requirement comprises obtaining at least one of the quality of service requirement, the origin location, or the destination location via a message sent from a vehicle-to-everything-enabled device.

3. The method of claim 2, wherein the quality of service requirement is specified by a user of the vehicle-to-everything-enabled device.

4. The method of claim 2, wherein the quality of service requirement is specified by an application executed by the vehicle-to-everything-enabled device.

5. The method of claim 2, wherein obtaining the quality of service requirement, the origin location, and the destination location comprises inferring at least one of the quality of service requirement, the origin location, or the destination location.

6. The method of claim 1, further comprising obtaining international mobile subscriber identity-related information.

7. The method of claim 6, wherein determining the optimized route is further based upon the international mobile subscriber identity-related information.

8. The method of claim 1, further comprising providing the optimized route to a vehicle-to-everything-enabled device.

9. A computer-readable storage medium comprising instructions that, when executed by a processor, cause the processor to perform operations comprising:
Obtaining a quality of service requirement, an origin location, and a destination location;
obtaining a key performance indicator;
selecting a route optimization model for the quality of service requirement; and
determining, based upon the route optimization model and the key performance indicator, an optimized route from the origin location to the destination location that satisfies the quality of service requirement.

10. The computer-readable storage medium of claim 9, wherein obtaining the quality of service requirement comprises obtaining at least one of the quality of service requirement, the origin location, or the destination location via a message sent from a vehicle-to-everything-enabled device.

11. The computer-readable storage medium of claim 10, wherein the quality of service requirement is specified by a user of the vehicle-to-everything-enabled device.

12. The computer-readable storage medium of claim 10, wherein the quality of service requirement is specified by an application executed by the vehicle-everything-enabled device.

13. The computer-readable storage medium of claim 10, wherein obtaining the quality of service requirement, the origin location, and the destination location comprises inferring at least one of the quality of service requirement, the origin location, or the destination location.

14. The computer-readable storage medium of claim 9, wherein the operations further comprise obtaining international mobile subscriber identity-related information.

15. The computer-readable storage medium of claim 14, wherein determining the optimized route is further based upon the international mobile subscriber identity-related information.

16. The computer-readable storage medium of claim 9, wherein the operations further comprise providing the optimized route to a vehicle-to-everything-enabled device.

17. A method comprising:
obtaining, by a route optimization system comprising a processor, a quality of service requirement, an origin location, and a destination location;
determining, by the route optimization system, all possible routes from the origin location to the destination location;
sorting, by the route optimization system, the all possible routes based upon a criterion;
sampling, by the route optimization system, locations along each route of the all possible routes;
predicting, by the route optimization system, based upon a route optimization model, a quality of service at each of the locations; and
determining, by the route optimization system, a least cost route of the all possible routes that satisfies the quality of service requirement.

18. The method of claim 17, wherein the criterion is associated with a vehicle, and wherein the criterion comprises a time or a distance for the vehicle to travel from the origin location to the destination location.

19. The method of claim 17, wherein the criterion is associated with a mobile network operator, and wherein the criterion comprises a monetary value or a metric of network resources used for providing a service to a vehicle-to-everything-enabled device.

20. The method of claim 17, further comprising providing the least cost route to a vehicle-to-everything-enabled device.
